(19) United States
(12) Patent Application Publication
(10) Pub. No.: US 2015/0154241 A1
(43) Pub. Date: Jun. 4, 2015

(54) ELECTRONIC DEVICE AND METHOD FOR QUERYING CONTACT PERSONS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIAN QIAN, Shenzhen (CN)

(21) Appl. No.: 14/542,839

(22) Filed: Nov. 17, 2014

(30) Foreign Application Priority Data
Nov. 30, 2013 (CN) 201310621962.4

(51) Int. Cl. G06F 17/30; G06F 3/0488; G06F 3/0484

(52) U.S. Cl. CPC G06F 17/30342; G06F 3/04842; G06F 3/04883; G06F 17/30554

(57) ABSTRACT

An electronic device includes a touch input device to receive touch inputs and a storage device to store a plurality of information of contact persons. The electronic device can respond to a user input to create an index list recording relationships between the information of the contact persons and graphic information. When the user inputs graphic information via the touch input device, the electronic device queries the information of the contact person corresponding to the graphic information input by the user according to the created index list.

### CROSS-REFERENCE TO RELATED APPLICATIONS

This application claims priority to Chinese Patent Application No. 201310621962.4 filed on Nov. 30, 2013, the contents of which are incorporated by reference herein.

### FIELD

The subject matter herein generally relates to information querying, and particularly to an electronic device, a system and a method for querying contact persons.

### BACKGROUND

If a user wants to communicate with a contact person, querying the contact person from a contact list is necessary.

### BRIEF DESCRIPTION OF THE DRAWINGS

Implementations of the present technology will now be described, by way of example only, with reference to the attached figures.

FIG. 1 is a block diagram illustrating an example embodiment of an electronic device capable of querying contact persons.

FIG. 2 is a flow chart illustrating an example embodiment of a method for querying contact persons.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

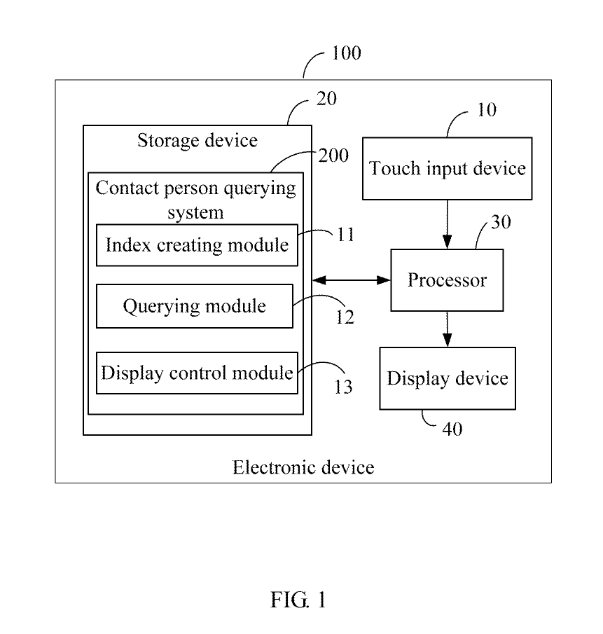

FIG. 1 illustrates a block diagram of an electronic device 100. The electronic device 100 can be a mobile phone, a personal digital assistant, a tablet computer, and the like. The electronic device 100 can associate different graphic information with different contact persons, and when a user input a graphic information, the electronic device 100 can query the contact person corresponding to the graphic information input by the user. In at least one embodiment, the electronic device 100 can include a touch input device 10, a storage device 20, a processor 30, and a display device 40. The touch input device 10, the storage device 20, and the display device 40 are coupled to the processor 30. In at least one embodiment, the touch input device 10 and the display device 40 can be integrated to form a touch input screen. In one embodiment, the processor 30 can be a central processing unit, a digital signal processor, or a single chip, for example. The storage device 20 can be an internal storage system, such as a flash memory, a random access memory (RAM) for temporary storage of information, and/or a read-only memory (ROM) for permanent storage of information. The storage device 20 can also be a storage system, such as a hard disk, a storage card, or a data storage medium. The storage device 20 can include volatile and/or non-volatile storage devices. In at least one embodiment, the storage device 20 can include two or more storage devices such that one storage device is a memory and the other storage device is a hard drive. Additionally, one or more of the storage devices 20 can be located either entirely or partially external relative to the electronic device 100.

The touch input device 10 is configured to receive input information in response to user's touch inputs. In this embodiment, the input information can include a graphic information. The graphic information can be a geometric shape, such as a circle, a triangle, a cross, and the like. In this embodiment, the touch input device 10 analyzes a track of the user's touch input, and determines the graphic information input by the user according to the analyzed track of the user's touch inputs.

The storage device 20 stores a contact list. The contact list can include a number of names of contact persons and contact information of the contact persons. The name of each contact person name can be predefined by the user. The contact information of each contact person can include a phone number, an e-mail address, and the like.

In this embodiment, the storage device 20 further can store a contact person querying system 200. The contact person querying system 200 can include a number of modules, which are collection of software instructions stored in the storage device 20 and executed by the processor 30. In at least one embodiment, the contact person querying system 200 can include an index creating module 11, a querying module 12, and a display control module 13.

The index creating module 11 is configured to respond to a user input to create an index list recording relationships between the names of the contact persons recorded in the contact list and the graphic information input by the user. For example, in the index list, a name of a contact person “John” corresponds to a circle, and another name of another contact person “Sam” corresponds to a cross. In at least one embodiment, the index list can be created as follows: the index creating module 11 obtains the graphic information the user input on the touch input device 10, then the index creating module 11 associates different graphic information input by the user with names of different contact persons in response to user input to obtain the relationships between the names of the contact persons and the graphic information, thus creating the index list including the relationships between the names of the contact persons and the graphic information. In other embodiments, the index list can be created as follows: the index creating module 11 can control the display device 40 to display a number of pre-stored graphic information, the user can select different graphic information to associate with names of different contact persons, thus creating the index list including the relationships between the names of all of contact persons and the graphic information. The index creating module 11 further can store the index list to the storage device 20.

The querying module 12 is used to obtain graphic information input by the user on the touch input device 10 and query the name of the contact person corresponding to the graphic information input by the user according to the index list. The querying module 12 further queries the contact information corresponding to the queried name of the contact person according to the contact list. For example, if the user wants to query contact information of the contact person “John”, the user can input a circular pattern on the touch input device 10, the querying module 12 can query the contact person “John” according to the circular input by the user and the index list, and then query the contact information of “John” from the contact list.

The display control module 13 is used to control the display device 40 to display the name of the contact person and the contact information queried by the querying module 12.

In this embodiment, the display module 13 further controls the display device 40 to display an interface to guide the user to do interactive operations, such as display the track of the user input, display a dial icon to guide the user to make a call and the like.

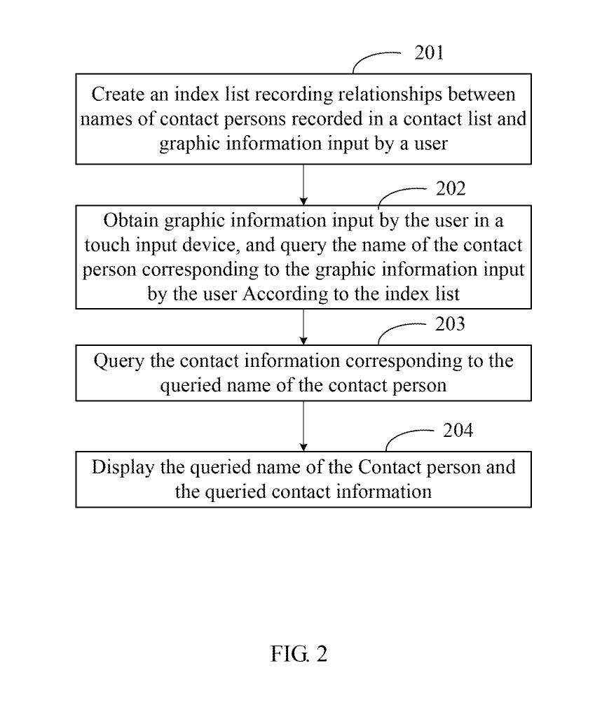

FIG. 2 illustrates an embodiment of a contact person querying method applied in an electronic device. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Additionally, the illustrated order of blocks is by example only and the order of the blocks can be changed. The example method can begin at block 201.

At block 201, an index creating module responds to a user input to create an index list recording relationships between the names of the contact persons recorded in a contact list and graphic information input by the user.

At block 202, a querying module obtains graphic information input by a user, and queries the name of the contact person corresponding to graphic information input by the user according to the index list created by the index creating module.

At block 203, the querying module queries the contact information corresponding to the queried name of the contact person.

At block 204, a display control module controls a display device to display the name of the contact person and the contact information corresponding to the name of the contact person queried by the querying module.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device comprising:
a display device;
a touch input device configured to receive graphic information input by users,;
a processor coupled to the display device and the touch input device;
a storage device coupled to the processor and configured to store a contact list, the contact list comprising a plurality of names of contact persons and contact information corresponding to each of the names of contact persons;
an index creating module, stored in the storage device, comprising at least one instruction configured to cause the processor to create an index list in response to user's touch input, the index list comprising relationships between the names of the contact persons recorded in the contact list and the graphic information input by the users; and
a querying module, stored in the storage device, comprising at least one instruction configured to cause the processor to obtain the graphic information the user input on the touch input device, query the name of the contact person corresponding to the graphic information input by the user according to the index list, and query the contact information corresponding to the queried name of the contact person.

2. The electronic device of claim 1, further comprising a display control module, stored in the storage device, comprising at least one instruction configured to cause the processor to control the display device to display the name of the contact person and the contact information queried by the processor.

3. The electronic device of claim 1, wherein the display module further cause the processor to control the display device to display an interface to guide the user to do interaction operations.

4. The electronic device of claim 1, wherein the index list is created as follows: the index list creating module cause the processor to obtain the graphic information input by the user on the touch input device, and associate different graphic information input by the user with names of different contact persons to obtain the relationships between the names of the contact persons and the graphic information, thus create the index list including the relationships between the names of the contact persons and the graphic information.

5. The electronic device of claim 1, wherein the index list is created as follows: the index list creating module cause the processor to control the display device to display a number of pre-stored graphic information, the user can select graphic information to be associated with corresponding name of contact person from the pre-stored graphic information to associate different graphic information with names of different contact person, thus to create the index list including the relationship between the names of all of the contact persons and the graphic information.

6. A contact person querying method applied in an electronic device, the electronic device comprising a touch input device, a processor, and a storage device storing a contact list, the contact list comprising a plurality of name of contact persons and contact information corresponding to each of the name of the contact persons, the method comprising:
creating an index list by the processor in response to user's touch input, the index list comprising relationships between the names of the contact persons and graphic information input by a user;
obtaining graphic information input by the user, and querying the name of the contact person corresponding to the graphic information input by the user according to the index list.

7. The contact person querying method of claim 6, further comprising:
querying the contact information corresponding to the name of contact person queried by the processor; and
displaying the name of the contact person queried by the processor and the contact information corresponding to the name of the contact person queried by the processor.

8. The contact person querying method of claim 6, wherein the index list is created as follows:
obtaining the graphic information input by the user on the touch input device;
associating different graphic information input by the user with names of different contact persons to obtain the relationships between the names of the contact persons and the graphic information; and
creating the index list comprising the relationships between the names of the contact persons and the graphic information.

9. The contact person querying method of claim 6, wherein the index list is created as follows:
controlling the display device to display a number of pre-stored graphic information;
selecting graphic information to be associated with corresponding name of contact person form the pre-stored graphic information to associate different graphic information with names of different contact person;
creating the index list comprising the relationships between the names of the contact persons and the graphic information.
